(19) United States
(12) Patent Application Publication
(10) Pub. No.: US 2026/0243054 A1
(43) Pub. Date: Aug. 20, 2026

(54) METHOD FOR OPERATING AUTOMATIC MINING OF MINING ELECTRIC SHOVEL BASED ON AUXILIARY VISION

(71) Applicant: China University of Mining and Technology, Jiangsu (CN)

(72) Inventors: Gang SHEN, Jiangsu (CN); Yu TANG, Jiangsu (CN); Yongcun GUO, Jiangsu (CN); Jin CHANG, Jiangsu (CN); Gongbo ZHOU, Jiangsu (CN); Zhencai ZHU, Jiangsu (CN); Hui XIE, Jiangsu (CN); Ziming KOU, Jiangsu (CN); Juan WU, Jiangsu (CN); Zhiyuan SHI, Jiangsu (CN); Hao LU, Jiangsu (CN); Yuxing PENG, Jiangsu (CN); Qingguo WANG, Jiangsu (CN)

(73) Assignee: China University of Mining and Technology, Jiangsu (CN)

(21) Appl. No.: 18/840,499

(22) PCT Filed: Aug. 3, 2023
(86) PCT No.: PCT/CN2023/110975

§ 371 Date: Aug. 22, 2024

(30) Foreign Application Priority Data
Apr. 21, 2023 (CN) 202310439200.6

(51) Int. Cl. E02F 9/20; E02F 9/26; E21C 47/02

(52) U.S. Cl. CPC E02F 9/205; E02F 9/2029; E02F 9/262; E02F 9/265; E21C 47/02

(57) ABSTRACT

Disclosed is a method for operating an automatic mining of a mining electric shovel based on an auxiliary vision, including establishing a spatial coordinate system at a mining electric shovel and obtaining forward kinematics of a working device of the mining electric shovel through a D-H mean; implementing a three-dimensional reconstruction of the material pile through the binocular camera and selecting appropriate starting and ending positions of the first excavation; selecting a function y_{w}=f_{w}(x,t) as a first excavation trajectory of the mining electric shovel; real-timely monitoring through a force sensor whether a large coal rock block exists; recording a position of a current bucket tooth tip in a case of where the large coal rock block is monitored; adopting a means for planning downward excavation paths, after the avoidance is completed.

### TECHNICAL FIELD

The present disclosure relates to the technical field of electric shovel, and especially relates to a method for operating an automatic mining of a mining electric shovel based on an auxiliary vision.

### BACKGROUND

Electric shovel, also called as rope shovel or steel cable shovel, that is, mechanical electric excavator, is a single bucket excavator by using transmission components such as gears, chains, and cable pulley groups to transmit powers. Mining electric shovel is generally used for coal mining in open-pit mines. Due to the low coal mining efficiency of traditional manual operation of the mining electric shovel, and in a case where the large coal rock block appears by using the mining electric shovel during the excavation process, operators usually adopts the methods of increasing the output power of the motor or ending the excavation operation to cope with, which easily cause phenomena of “overload”, “underbreak” and the like, leading to a reduction in the service life of the transmission motor and substandard material filling rate of the bucket excavation. Therefore, it is urgent to invent a method for operating an automatic mining of a mining electric shovel based on an auxiliary vision.

### SUMMARY

The objectives of the present disclosure is to provide a method for operating an automatic mining of a mining electric shovel based on an auxiliary vision. And the method can implement automatic mining operations of the mining electric shovel during the mining process with the help of the auxiliary vision.

In order to achieve above objectives, provided is a method for operating an automatic mining of a mining electric shovel based on an auxiliary vision. And the method includes the following steps.

In Step S1, a binocular camera is calibrated by a Matlab toolbox. After the calibration is completed, the binocular camera is installed at a center of a front arm of the mining electric shovel, for extracting morphological features of an excavated material pile.

In Step S2, spatial coordinate systems are established by taking O0, O1, O2, O3 as origins at a joint of the mining electric shovel and a center of the binocular camera, respectively. And forward kinematics of a working device of the mining electric shovel is obtained through a D-H mean.

In Step S3, appropriate starting and ending positions for a first excavation are selected by a three-dimensional model of the material pile in the Matlab.

In Step S4, a function y_{w}=f_{w}(x,t) is selected as a first excavation trajectory of the mining electric shovel, and an expected trajectory of a dipper arm elongation d and an expected trajectory of an inclination angle θ are obtained by using the forward kinematics of the mining electric shovel and a plane geometry relation. Instructions are sent to a variable frequency alternating current motors through the expected trajectory of the dipper arm elongation d and the expected trajectory of the inclination angle θ, and an execution mechanism of the mining electric shovel are driven to carry out an excavation work.

In Step S5, it is real-timely monitored through a force sensor installed on a transmission part that whether a large coal rock block exists in an excavation direction of a bucket during an excavation process of the mining electric shovel. In a case where the large coal rock block is monitored in the bucket, a current position of a current bucket tooth tip is recorded, and the excavation work is terminated.

In Step S6, the large coal rock block in front of the excavation direction of the bucket is avoided by adopting a means for planning downward excavation paths.

In Step S7, starting and ending positions for a second excavation and a mining trajectory function y_{w2}=f_{w2}(x,t) are selected.

In Step S8, the expected trajectory of the dipper arm elongation d and the expected trajectory of the inclination angle θ are obtained by using the forward kinematics of the mining electric shovel and the plane geometry relation, thereby continuing to complete an entire excavation operation.

Further, in Step S1, a chessboard calibration mean is adopted to calibrate in a calibration of the binocular camera, and multiple sets of chessboard photos with different directions and angles are taken as calibration samples.

Further, in Step S1, a means for extracting the morphological features of the excavated material pile specifically includes following steps.

Images of the excavated material pile are obtained, the images of material pile to be excavated are captured and obtained through the installed binocular camera.

Images are corrected, a distortion correction and a stereo correction are performed on the obtained images of the material pile.

Features are extracted, feature points are detected and extracted from left eye images of the material pile and right eye images of the material pile.

A stereo matching is performing, stereo matchings of the left eye images and the right eye images are completed by using the extracted feature points, and a disparity map of the material pile is obtained.

Voids are filled, invalid errors caused by an uneven lighting are handled by using a mean value filling mean.

A disparity is converted to a depth, a processed disparity map is converted into a depth map through a geometric mean.

A 3D reconstruction is performed, after the depth map is transformed into point cloud data through a coordinate transformation, the point cloud data are imported into Matlab are presented in a form of a stereo map.

Further, in Step S2, spatial coordinate systems are established by taking O0, O1, O2, O3 as origins at a joint of the mining electric shovel and a center of the binocular camera, respectively. X₀, Y₀, X₁, Z₁, X₂, Z₂, X₃, and Y₃ are on the same plane, Z₀, Y₁, Y₂, and Z₃ are perpendicular to the plane, coordinate axes X₀ and X₃ are oriented horizontally to a right, coordinate axes Y₀ and Y₃ are oriented vertically upward, a coordinate axis X₁ is parallel to a coordinate axis X₂, a direction is along the shovel arm; the coordinate axis Z₁ is parallel to the coordinate axis Z₂, and the direction is along the shovel rod.

Further, in Step S4, the first excavation trajectory of the mining electric shovel is selected as a logarithmic spiral ρ=ρ₀e^{φ cot δ}.

Further, in Step S5, a means for monitoring the large coal rock block is to observe readings of the force sensor, in a case where an upper limit of a fluctuation exceeds a specified threshold, it is determined that the large coal rock block exists in front of the excavation direction of the bucket of the mining electric shovel.

Further, in Step S6, a means for planning the downward excavation paths includes following steps.

(1) Firstly, the bucket tooth tip is moved horizontally backward by a distance S.

(2) Subsequently, the bucket tooth tip is moved vertically downwards by a distance H.

(3) Eventually, the bucket tooth tip is moved horizontally forwards by a distance S to a point (x₀, y₀−H) directly below a first excavation stop point (x₀, y₀).

(4) It is monitored that whether the readings of the force sensor exceed the threshold at this time instant, in a case where the readings exceed the threshold, the bucket tooth tip continues to be moved horizontally backwards by the distance S, subsequently to be moved vertically downwards by the distance H, and eventually to be moved horizontally forwards by the distance S to the a point (x₀, y₀−2H) directly below the first excavation stop point (x₀, y₀) and it is repeated sequentially until the readings of the force sensor do not exceed the threshold.

Further, in Step S7, the starting and ending positions for the second excavation are an end point of an avoidance path and a selected end point of the first excavation, respectively.

Further, in Step S7, a second excavation trajectory of the mining electric shovel is selected as a logarithmic spiral ρ=ρ₀e^{φ cot δ}.

Comparing with the prior art, the beneficial effects of the present disclosure are as follows.

(1) The present disclosure combines the machine vision with the mining electric shovel, which can achieve automated operations of the mining electric shovel and improve the automation level of the mining electric shovel.

(2) The present disclosure obtains the forward kinematics of a working device of the mining electric shovel through a D-H mean and by establishing a spatial coordinate system, which can accurately control the excavation of the bucket.

(3) By using automatically monitoring large coal rocks and formulating reasonable avoidance paths, the present disclosure can solve the problems, such as “overload” and “under break” of mining electric shovels caused by encountering the large coal rock block during the excavation in the traditional manual operations, thereby improving the service life of the transmission motor and ensuring the full bucket rate of the excavated materials.

### BRIEF DESCRIPTION OF THE DRAWINGS

FIG. 1 illustrates a flow chart diagram of a method for operating an automatic mining of a mining electric shovel based on an auxiliary vision in the present disclosure.

FIG. 2 illustrates a schematic diagram of an installation position of a binocular camera on a mining electric shovel in the present disclosure.

FIG. 3 illustrates a schematic diagram of spatial coordinate systems of the mining electric shovel in the present disclosure.

FIG. 4 illustrates a plane geometric relation diagram between a polar diameter ρ, a polar angle φ, an elongation d, and an inclination angle θ of the present disclosure.

FIG. 5 illustrates a path planning scheme diagram for avoiding a large coal rock block of the present disclosure.

### DETAILED DESCRIPTION OF THE EMBODIMENTS

The present disclosure will be specifically described in conjunction with the accompanying drawings and the specific embodiments.

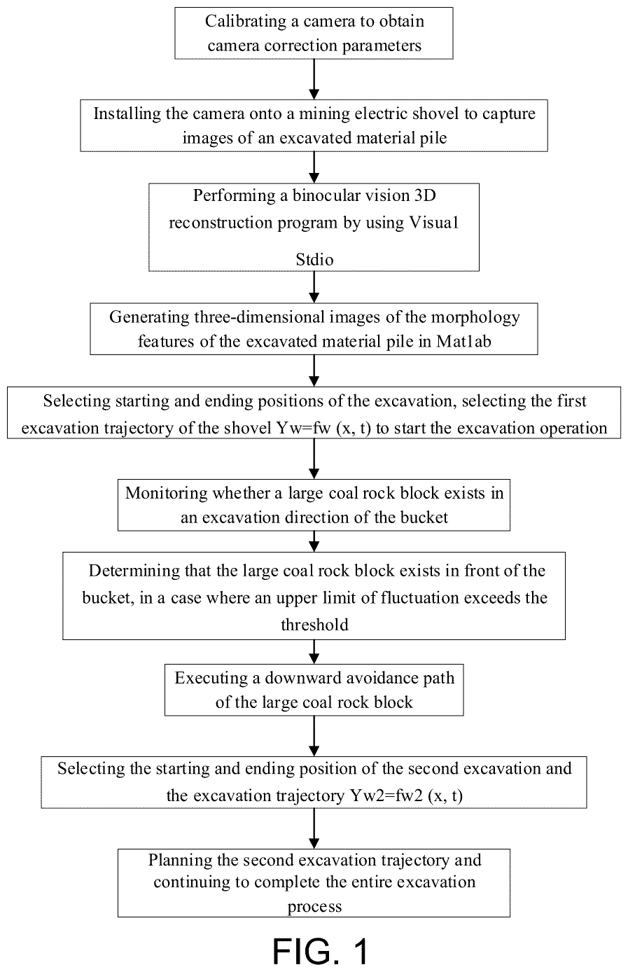

As illustrated in FIG. 1, provided is a method for operating an automatic mining of a mining electric shovel based on an auxiliary vision. The method is as follows.

First, the selected binocular camera is calibrated by using the Stereo Camera Calibrator dual target calibration toolbox in Matlab (a commercial mathematical software produced by Math Works in the United States), and the parameters such as the left eye intrinsic parameter matrix K1 and the right eye intrinsic parameter matrix K2, the distortion coefficient vectors D1 and D2, the rotation matrix R, and the translation vector T are obtained.

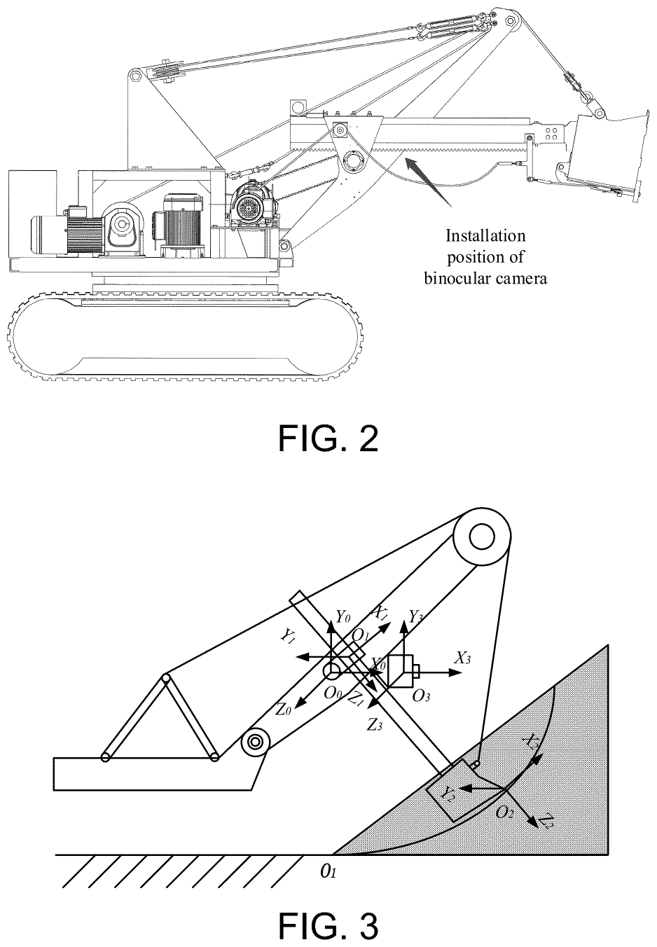

Subsequently, as illustrated in FIG. 2, the calibrated binocular camera is installed on the dipper arm base of the mining electric shovel through the bolts, and the base angle is adjusted to ensure that the lens of the binocular camera is parallel to the plane on the front side of the mining electric shovel chassis. The Visual Studio is used to call the binocular camera to capture images of the excavated material pile, and then the image correction, the feature extraction, the stereo matching, the hole filling, and the depth conversion are performed to obtain the txt point cloud data file of the excavated material pile.

In order to facilitate the planning of subsequent automatic excavation methods, it is needed to place the point cloud of the material pile surface and the excavation trajectory in the same coordinate system, and solve the kinematic forward solution of the working device of the mining electric shovel.

As illustrated in FIG. 3, spatial coordinate systems are established by taking O0, O1, O2, as origins at a joint of the mining electric shovel and a center of the binocular camera, respectively. Three origins are established at the joints and one origin is established at the binocular camera. X₀, Y₀, X₁, Z₁, X₂, Z₂, X₃, and Y₃ are on the same plane, Z₀, Y₁, Y₂, and Z₃ are perpendicular to this plane, coordinate axes X₀ and X₃ are oriented horizontally to a right, coordinate axes Y₀ and Y₃ are oriented vertically upward, coordinate axis X₁ is parallel to coordinate axis X₂, a direction is along the shovel arm; the coordinate axis Z₁ is parallel to the coordinate axis Z₂, and the direction is along the shovel rod. It is assumed that θ is the angle at which the electric shovel rotates from the coordinate axis X₀ to the coordinate axis X₁ around the coordinate axis Z₀, L₁ is the distance along the coordinate axis X₁ between the origin O₀ of the joint 0 coordinate system and the origin O₁ of the joint 1 coordinate system, d is the distance along the Z₂ coordinate axis between the origin O₁ of the joint 1 coordinate system and the origin O₂ of the joint 2 coordinate system, L₂ is the distance along the Z₂ coordinate axis between the origin O₁ of the joint 1 coordinate system and the origin O₂ of the joint 2 coordinate system, and L₃ is the distance along the X₃ coordinate axis between the origin O₀ of the joint 0 coordinate system and the origin O₃ of the binocular camera coordinate system.

After the coordinate system is transformed once, the corresponding transformation matrix is solved, that is, the pose transformation from the origin O₃ of the binocular camera coordinate system to the origin O₀ of the joint 0 coordinate system, thus achieving the goal of placing the point cloud of the material pile surface and the excavation trajectory in the same coordinate system.

The DH parameter table as shown in Table 1 is obtained by the established coordinate system, and the DH parameter table is as shown in Table 1.

TABLE 1
D-H Parameter Table of Working Device of Mining Electric Shovel

| Joint i | dᵢ | θᵢ | aᵢ | αᵢ |
|---|---|---|---|---|
| 1 | 0 | θ | L₁ | 90° |
| 2 | d | 0 | L₂ | 0 |

The coordinate system with O₀ as the origin is transformed twice into the coordinate system with O₂ as the origin, and the pose transformation matrix T from the saddle to the bucket tooth tip is obtained. Therefore, the forward kinematics of the working device of the mining electric shovel is

$$\{ \begin{matrix}{p}_{x} = {L}_{2} cos θ + d sin θ + {L}_{1} cos θ \\ {p}_{y} = {L}_{2} sin θ - d cos θ + {L}_{1} sin θ\end{matrix} .$$

The txt point cloud data file of the excavated material pile obtained above is imported into Matlab and is present in the form of a 3D image. An appropriate excavation starting point (xₛ, yₛ) and an appropriate excavation ending point (xₛ, yₛ) can be selected by the operators according to the current shape of the excavated material pile.

A function y_{w}=f_{w}(x,t) is selected as the excavation trajectory of the mining electric shovel, a logarithmic spiral line ρ=ρ₀e^{φ cot δ} is preferably selected herein, where ρ₀ denotes the initial elongation of the dipper arm and δ denotes the cutting angle. ρ₀ and δ are converted into a rectangular form

$$\{ \begin{matrix}x = {ρ}_{0} {e}^{φ cot δ} cos φ \\ y = {ρ}_{0} {e}^{φ cot δ} sin φ\end{matrix} ,$$

and since the rectangular coordinate system is a coordinate system where the X-axis is oriented vertically downward and the Y-axis is oriented horizontally rightward, the rectangular coordinate system needs to be rotated counterclockwise for 90° around the Z-axis, and with the help of coordinate system transformation, the excavation trajectory function in the base coordinate system is obtained as

$$\{ \begin{matrix}x = {ρ}_{0} {e}^{φ cot δ} sin φ \\ y = {ρ}_{0} {e}^{φ cot δ} cos φ\end{matrix} .$$

In order to ensure a smooth excavation trajectory without sudden speed variations, and the excavation can be smoothly stopped during electric shovel excavation operations, it is necessary to satisfy φ(0)=φ₀, φ(t_{f})=φ_{f}, \dot{φ}(0)=0, \dot{φ}(t_{f})=0, \ddot{φ}(0)=0, \ddot{φ}(t_{f})=0 where, φ(t), \dot{φ}(t), \ddot{φ}(t), φ₀, φ_{f}, t_{f} denote the angular displacement, the angular velocity, the angular acceleration, the excavation initial angle, the termination angle, and the end time of bucket tooth tip, respectively. According to the conditions that need to be satisfied for a stable excavation of the mining electric shovel, a 5th degree polynomial is selected to interpolate and fit the tooth tip angle of the mining electric shovel bucket, that is, the polar angle φ, to obtain the functional relation of the polar angle φ relating to time t:

$$φ ( t ) = {φ}_{0} + \frac{10 ( {φ}_{f} - {φ}_{0} )}{{t}_{f}^{3}} {t}^{3} + \frac{- 15 ( {φ}_{f} - {φ}_{0} )}{{t}_{f}^{4}} {t}^{4} + \frac{6 ( {φ}_{f} - {φ}_{0} )}{{t}_{f}^{5}} {t}^{5} .$$

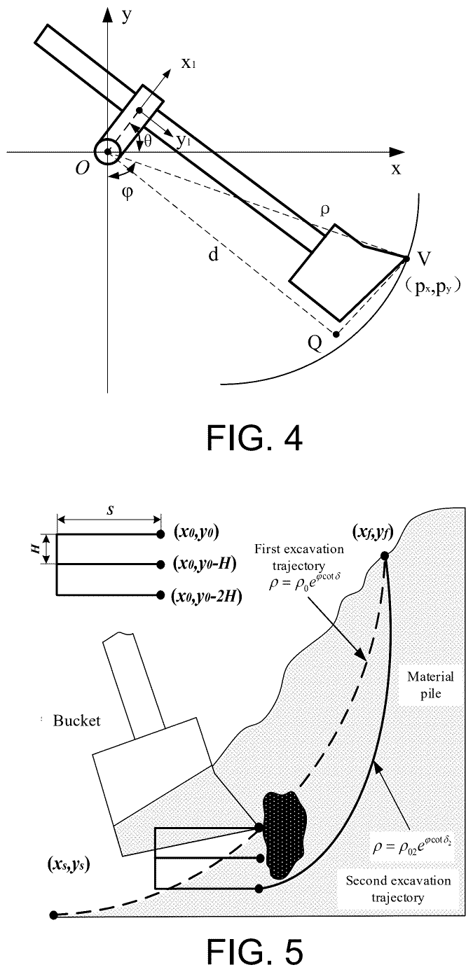

According to the kinematic forward solution of the working device of the mining electric shovel obtained above and the geometric relation as illustrated in FIG. 4, the expressions of ρ and φ relating to pₓ and p_{y} are obtained and expressed as

$$ρ = \sqrt{{p}_{x}^{2} + {p}_{y}^{2}} , tan φ = \vert \frac{{p}_{x}}{{p}_{y}} \vert .$$

Then, the relation expression between the polar diameter ρ and polar angle φ as well as the elongation d and inclination angle θ is obtained and expressed as

$$\{ \begin{matrix}d = \sqrt{{ρ}^{2} - {( {L}_{1} + {L}_{2} )}^{2}} \\ θ = arctan \frac{d}{{L}_{1} + {L}_{2}} - ( \frac{π}{2} - φ )\end{matrix} .$$

From this, the function d(t) of the dipper arm elongation d relating to time t and the function θ(t) of the inclination angle θ relating to time t can be obtained. Instructions are sent to a variable frequency alternating current motors through the expected trajectory of a dipper arm elongation d and the expected trajectory of the inclination angle θ, and an execution mechanism of the mining electric shovel are driven to carry out an excavation work.

During the excavation process, the real-time excavation resistance can be obtained by the force sensors respectively installed at the connection between the bucket and the end of the lifting rope, as well as between the pushing motor and the synchronous pulley. It is monitored that whether the fluctuation upper limit of the reading of the force sensor exceeds the specified threshold, in a case where the readings of the force sensors suddenly increase and exceed the specified threshold, it indicates that the tooth tip of the mining electric shovel bucket is in contact with a large coal rock block. After the current coordinate (x₀, y₀) of the bucket tooth tip is recorded, the mining electric shovel stops the excavation work and begins to execute instructions to avoid the large coal rock block.

In order to ensure sufficient excavation quantity of the bucket, a downward path is adopted to avoid the large coal rock block. The specific operations are as illustrated in FIG. 5. (1) Firstly, the bucket tooth tip is moved horizontally backward by a distance S. Subsequently, the bucket tooth tip is moved vertically downwards by a distance H. Eventually, the bucket tooth tip is moved horizontally forwards by a distance S to a point (x₀, y₀−H) directly below a first excavation stop point (x₀, y₀). It is monitored that whether the readings of the force sensor exceed the threshold at this time instant, in a case where the readings exceed the threshold, the bucket tooth tip continues to be moved horizontally backwards by the distance S, subsequently to be moved vertically downwards by the distance H, and eventually to be moved horizontally forwards by the distance S to the a point (x₀, y₀−2H) directly below the first excavation stop point (x₀, y₀); and it is repeated sequentially until the readings of the force sensor do not exceed the threshold. In a case where a large coal rock is detected again in front of the bucket during the second excavation after successfully avoiding the large coal rock, the above steps are continued to be performed until the readings of the force sensors do not exceed the threshold.

Here is a specific embodiment where a large coal rock is encountered during the excavation process and the avoidance path instruction is executed once. In a case where the bucket tip moves to a point (x₀, y₀−H) directly above the excavation stop point (x₀, y₀), and the readings of the force sensors are monitored that the readings do not exceed the threshold, it indicates successful avoidance of the large coal rock block. Then, the end point (x₀, y₀−H) of the avoidance path is taken as a starting point and the points (x_{f}, y_{f}) selected from the visual morphology map of the excavated material pile is continued to be used as the end point. Logarithmic spiral is selected as the mining trajectory function for the second excavation, two sets of coordinates (ρₛ, φₛ), and (ρ_{f}, φ_{f}) are obtained through the geometric relation expression

$$ρ = \sqrt{{p}_{x}^{2} + {p}_{y}^{2}} , tan φ = \vert \frac{{p}_{x}}{{p}_{y}} \vert ,$$

and the two sets of the coordinates are input into the mining trajectory function

$$ρ = {ρ}_{02} {e}^{{φ cot δ}_{2}} to obtain \{ \begin{matrix}{ρ}_{s} = {ρ}_{0} {e}^{{φ cot δ}_{2}} \\ {ρ}_{f} = {ρ}_{0} {e}^{{φ cot δ}_{2}}\end{matrix} ,$$

the initial elongation ρ₀ and the cutting angle δ of the second excavation trajectory can be obtained by solving. Next, the steps of the expected trajectory described above are repeated, by using the kinematic forward solution of the working device of the mining electric shovel and the plane geometric relation illustrated in FIG. 4, the expected trajectory of the dipper arm elongation d(t) and inclination angle θ(t) are obtained, and then the variable frequency AC motor is driven to work, and the entire excavation operation is continued to be completed.

The embodiments of the present disclosure are described in detail above in conjunction with the accompanying drawings, while the present disclosure is not limited to this. Various variations that can be made within the knowledge scope of those skilled in the art without departing from the purpose of the present disclosure are all within the protection scope of the claims of the present invention.

1. A method for operating an automatic mining of a mining electric shovel based on an auxiliary vision, the method comprising following steps:
Step S1, calibrating, by a Matlab toolbox, a binocular camera, installing, after calibration is completed, the binocular camera at a center of a front arm of the mining electric shovel, for extracting morphological features of an excavated material pile;
Step S2, establishing, by taking O0, O1, O2, O3 as origins, spatial coordinate systems at joints of the mining electric shovel and a center of the binocular camera, respectively, and obtaining, through a D-H mean, forward kinematics of a working device of the mining electric shovel;
Step S3, selecting, by a three-dimensional model of a material pile in the Matlab, appropriate starting and ending positions for a first excavation;
Step S4, selecting a function y_{w}=f_{w}(x,t) as a first excavation trajectory of the mining electric shovel, and obtaining, by using the forward kinematics of the mining electric shovel and a plane geometry relation, an expected trajectory of a dipper arm elongation d and an expected trajectory of an inclination angle θ, sending, through the expected trajectory of the dipper arm elongation d and the expected trajectory of the inclination angle θ, instructions to a variable frequency alternating current motor, and driving an execution mechanism of the mining electric shovel to carry out an excavation work;
Step S5, real-timely monitoring, through a force sensor installed on a transmission part, whether a large coal rock block exists in an excavation direction of a bucket during an excavation process of the mining electric shovel, recording, in a case where the large coal rock block is monitored in the bucket, a current position (x₀, y₀) of a bucket tooth tip, and terminating the excavation work;
Step S6, avoiding, by adopting a means for planning downward excavation paths, the large coal rock block in front of the excavation direction of the bucket;
Step S7, selecting starting and ending positions for a second excavation and a mining trajectory function y_{w2}=f_{w2}(x,t); and
Step S8, obtaining, by using the forward kinematics of the mining electric shovel and the plane geometry relation, the expected trajectory of the dipper arm elongation d and the expected trajectory of the inclination angle θ, thereby continuing to complete an entire excavation operation.

2. The method for operating the automatic mining of the mining electric shovel based on the auxiliary vision according to claim 1, wherein in the Step S1, a chessboard calibration mean is adopted to calibrate in the calibration of the binocular camera, and multiple sets of chessboard photos with different directions and angles are taken as calibration samples.

3. The method for operating the automatic mining of the mining electric shovel based on the auxiliary vision according to claim 1, wherein in the Step S1, a means for extracting the morphological features of the excavated material pile comprises:
obtaining images of the excavated material pile, capturing and obtaining, through the installed binocular camera, the images of material pile to be excavated;
correcting images, performing a distortion correction and a stereo correction on the obtained images of the material pile;
extracting features, detecting and extracting feature points from a left eye image of the material pile and a right eye image of the material pile;
performing a stereo matching, completing, by using the extracted feature points, stereo matchings of the left eye image and the right eye image, and obtaining a disparity map of the material pile;
filling voids, handling, by using a mean value filling mean, invalid errors caused by uneven lighting;
converting a disparity to a depth, converting, through a geometric mean, a processed disparity map into a depth map; and
performing a 3D reconstruction, importing, after the depth map is transformed into point cloud data through a coordinate transformation, the point cloud data into Matlab, and presenting in a form of a stereo map.

4. The method for operating the automatic mining of the mining electric shovel based on the auxiliary vision according to claim 1, wherein in the Step S2, the spatial coordinate systems are established by taking O0, O1, O2, O3 as the origins at the joints of the mining electric shovel and the center of the binocular camera, respectively, X₀, Y₀, X₁, Z₁, X₂, Z₂, X₃, and Y₃ are on a same plane, Z₀, Y₁, Y₂, and Z₃ are perpendicular to the plane, coordinate axes X₀ and X₃ are oriented horizontally to a right, coordinate axes Y₀ and Y₃ are oriented vertically upward, a coordinate axis X₁ is parallel to a coordinate axis X₂ with a direction along a shovel arm; a coordinate axis Z₁ is parallel to a coordinate axis Z₂ with a direction along a shovel rod.

5. The method for operating the automatic mining of the mining electric shovel based on the auxiliary vision according to claim 1, wherein in the Step S4, the first excavation trajectory of the mining electric shovel is selected as a logarithmic spiral ρ=ρ₀e^{φ cot δ}.

6. The method for operating the automatic mining of the mining electric shovel based on the auxiliary vision according to claim 1, wherein in the Step S5, a means for monitoring the large coal rock block is to observe readings of the force sensor, in a case where an upper limit of a fluctuation exceeds a specified threshold, the large coal rock block is determined to exist in front of the excavation direction of the bucket of the mining electric shovel.

7. The method for operating the automatic mining of the mining electric shovel based on the auxiliary vision according to claim 1, wherein in the Step S6, a means for planning the downward excavation paths comprises:
(1) firstly, horizontally moving the bucket tooth tip backward by a distance S,
(2) subsequently, vertically moving the bucket tooth tip downwards by a distance H,
(3) eventually, horizontally moving the bucket tooth tip forwards by the distance S to a point (x₀, y₀−H) directly below a first excavation stop point (x₀, y₀), and
(4) monitoring whether the readings of the force sensor exceed the threshold at this time instant, continually moving, in a case where the readings exceed the threshold, the bucket tooth tip horizontally backwards by the distance S, subsequently, vertically moving the bucket tooth tip downwards by the distance H, eventually, horizontally moving the bucket tooth tip forwards by the distance S to the a point (x₀, y₀−2H) directly below the first excavation stop point (x₀, y₀) and sequentially repeating until the readings of the force sensor do not exceed the threshold.

8. The method for operating the automatic mining of the mining electric shovel based on the auxiliary vision according to claim 1, wherein in the Step S7, the starting and ending positions for the second excavation are an end point of an avoidance path and a selected end point of the first excavation, respectively.

9. The method for operating the automatic mining of the mining electric shovel based on the auxiliary vision according to claim 1, wherein in the Step S7, a second excavation trajectory of the mining electric shovel is selected as a logarithmic spiral ρ=ρ₀e^{φ cot δ.}
